(19) United States
(12) Patent Application Publication
(10) Pub. No.: US 2022/0305446 A1
(43) Pub. Date: Sep. 29, 2022

(54) SELECTIVELY PERMEABLE POLYMERIC MEMBRANE

(71) Applicant: NITTO DENKO CORPORATION, Osaka (JP)

(72) Inventors: Bita Bagge, Vista, CA (US); Weiping Lin, Carlsbad, CA (US); Shijun Zheng, San Diego, CA (US); Isamu Kitahara, San Diego, CA (US); Peng Wang, San Diego, CA (US); Paul Bieghs, Oceanside, CA (US); Fabrice Dumont, Oceanside, CA (US); Takashi Kondo, Osaka (JP); Yuji Yamashiro, Osaka (JP)

(21) Appl. No.: 17/596,844

(22) PCT Filed: Jun. 17, 2020
(86) PCT No.: PCT/US2020/038240

§ 371 Date: Dec. 20, 2021

Related U.S. Application Data
(60) Provisional application No. 62/863,182, filed on Jun. 18, 2019.

(51) Int. Cl. B01D 71/80; B01D 69/10; B01D 71/52; B01D 69/14; B01D 71/56; B01D 69/02; B01D 67/00; B01D 53/26; B01D 53/22; F24F 3/14

(52) U.S. Cl. CPC B01D 71/80; B01D 69/10; B01D 71/52; B01D 69/148; B01D 71/56; B01D 69/02; B01D 67/0079; B01D 53/268; B01D 53/228; F24F 3/14; B01D 2325/04; F24F 2003/1435

(57) ABSTRACT

Described herein are crosslinked polymeric based composite membranes that provide selective resistance for gases while providing water vapor permeability. Such composite membranes have a high water/air selectivity in permeability. The methods for making such membranes and using the membranes for dehydrating or removing water vapor from gases are also described.

### CROSS-REFERENCE TO RELATED APPLICATIONS

This application claims the benefit of U.S. Provisional Application No. 62/863,182, filed Jun. 18, 2019, which provisional is incorporated herein in its entirety.

### FIELD

The present embodiments are related to gas separation membranes for applications such as removing water or water vapor from air or other gas streams and energy recovery ventilation (ERV).

### BACKGROUND

The presence of a high moisture level in the air may make people uncomfortable, and also may cause serious health issues by promoting growth of mold, fungus, as well as dust mites. In manufacturing and storage facilities, high humidity environments may accelerate product degradation, powder agglomeration, seed germination, corrosion, and other undesired effects, which is a concern for chemical, pharmaceutical, food and electronic industries. One of the conventional methods to dehydrate air includes passing wet air through hydroscopic agents, such as glycol, silica gel, molecular sieves, calcium chloride, and phosphorus pentoxide. However, this method has many disadvantages: for example, the drying agent has to be carried over in a dry air stream, and the drying agent also requires replacement or regeneration over time making the dehydration method costly and time consuming. Another conventional method to dehydrate air is a cryogenic method wherein the wet air is compressed and cooled to condense moisture. However, this method is highly energy consuming.

Compared with the conventional dehydration or dehumidification methods described above, membrane-based gas dehumidification technology has distinct technical and economic advantages. The advantages include low installation cost, easy operation, high energy efficiency and low process cost, as well as high processing capacity. This technology has been successfully applied in dehydration of nitrogen, oxygen, and compressed air. For energy recovery ventilator (ERV) system applications, such as inside buildings, it is desirable to provide fresh air from outside. Energy is required to cool and dehumidify the fresh air especially in hot and humid climates, where the outside air is much hotter and has more moisture than the air inside the building. The amount of energy required for heating or cooling and dehumidification can be reduced by transferring heat and moisture between the exhausting air and the incoming fresh air through an ERV system. The ERV system comprises a membrane which separates the exhausting air and the incoming fresh air physically, but allows the heat and moisture exchange. The required key characteristics of an ERV membrane include: (1) lower permeability of air and gases other than water vapors; (2) high permeability of water vapor for effective transfer of moisture between the incoming and the outgoing air stream while blocking the passage of other gases; and (3) high thermal conductivity for effective heat transfer.

There is a need of membranes with high permeability of water vapor and low permeability of air for ERV applications.

### SUMMARY

The disclosure relates to a membrane composition which may reduce water swelling and increase selectivity of H₂O/air permeability. Some membranes may provide improved dehydration as compared to traditional polymers, such as polyvinyl alcohols (PVA), poly(acrylic acid) (PAA), polyether ether ketone (PEEK), and polyether block amide (PEBA). Some membranes may comprise a hydrophilic inorganic filler. The polymeric membrane composition may be prepared by using one or more water soluble cross-linkers/hydrophilicity agents. Methods of efficiently and economically making these membrane compositions are also described. Water can be used as a solvent in preparing these membrane compositions, which makes the membrane preparation process more environmentally friendly and more cost effective.

Some embodiments include a dehydration membrane comprising: a porous support; and a composite coated on the porous support comprising a polyether block amide (PEBA) and at least one hydrophilic inorganic filler. In some embodiments, the composite coating increases moisture permeability and lowers gas permeability. In some embodiments, the hydrophilic inorganic filler can comprise an aluminum trihydrate (ATH), calcium chloride (CaCl₂)), a sodium silicate or a sodium aluminate. In some embodiments, the composite coating may further comprise a graphene oxide compound.

In some embodiments, the dehydration membrane has a gas permeance that is less than 1.0×10⁻⁷ L/(m²·s·Pa) as determined by the Differential Pressure Method. In some examples, the gas permeance is less than 1.0×10⁻⁸ L/(m²·s·Pa).

In some embodiments, the dehydration membrane has a water vapor transmission rate that is at least 3,400 g/m²/day as determined by ASTM E96 standard method. In some cases, the water vapor transmission rate is at least 4,200 g/m²/day.

Some embodiments include a method of making a dehydration membrane comprising the steps of: (1) mixing a PEBA and an inorganic filler in an aqueous mixture to generate a composite coating mixture; (2) applying the composite coating mixture on a porous support to form a coated support; (3) repeating step (2) as necessary in to achieve a desired thickness of between about 100 nm to about 3000 nm of coating on the porous support; and (4) curing the coated support at a temperature of about 60° C. to about 120° C. for about 30 seconds to about 3 hours to facilitate solvent evaporation and crosslinking. In some embodiments, step (1) can further comprise adding a graphene oxide compound to the mixture.

Some embodiments include an energy recovery ventilator, or energy recovery ventilator system comprising a membrane described herein.

Some embodiments include a method of dehydrating a gas, comprising applying a gas pressure gradient across the dehydration membrane described herein, wherein a gas to be dehydrated applies a higher water vapor pressure to a first side of the membrane than a gas in contact with a second side of membrane, wherein water vapor passes through the membrane from the gas to be dehydrated and into the gas in contact with the second side of the membrane. These and other embodiments are described in greater detail below.

### BRIEF DESCRIPTION OF THE DRAWINGS

FIG. 1 is a depiction of a possible embodiment of a selective dehydration membrane.

FIG. 2 is a diagram depicting the experimental setup for gas permeability testing.

### DETAILED DESCRIPTION

### General

A dehydration membrane includes a membrane that is relatively permeable to one material and relatively impermeable for another material. For example, a membrane may be relatively permeable to water vapor and relatively impermeable to gases such as oxygen and/or nitrogen. The ratio of permeability for different materials may be useful in describing their selective permeability.

### Dehydration Membrane

The present disclosure includes dehydration membranes where a highly selective hydrophilic composite material with high water vapor permeability, low gas permeability and high mechanical and chemical stability may be useful in applications where a dry gas or gas with low water vapor content is desired.

The present disclosure includes membrane coating composites comprising polyether-block-amide (PEBA) combined with at least one hydrophilic inorganic filler, such as a metal compound or salt, such as an aluminum compound or an aluminum salt, a calcium compound or a calcium salt, a sodium compound or a sodium salt, a silicon compound or a silicon salt, e.g. aluminum trihydride (ATH), calcium chloride (CaCl₂)), a sodium silicate and/or a sodium aluminate. The resulting composite membrane shows extraordinarily high-water vapor permeability and selectivity compared to PEBA alone. These new membranes can have an extremely positive impact on dehydration membrane and ERV membrane applications.

In some embodiments, the membranes may comprise multiple layers. In some embodiments, the dehydration membrane comprises a porous support and a composite coating. In some embodiments, the composite coating may comprise a PEBA and a hydrophilic inorganic filler. In some examples, the PEBA and the inorganic filler may be crosslinked. In some embodiments, the composite coating may be disposed on a surface of the porous support. In some embodiments, the composite may comprise a hydrophilicity agent. In some embodiments, the hydrophilicity agent may comprise a PEBA. In some embodiments, the composite may further comprise a graphene oxide (GO) compound. It is believed a PEBA copolymer may provide additional mechanical strength due to the polyamide's hard linear chains, and increased water permeability due to the polyether's ether chain linkages. It is further believed that PEBA's copolymer structure provides high selectivity for permeability of polar gases over non-polar gases. It is further believed that the hydrophilic inorganic fillers may intercalate within the PEBA matrix, providing the membrane with additional mechanical strength and reducing the matrix's pore size, thus resulting in high moisture permeability with low gas permeability. In addition, the selectively permeable membranes described herein may be prepared using water as a solvent, which may make the manufacturing process much more environmentally friendly and cost effective.

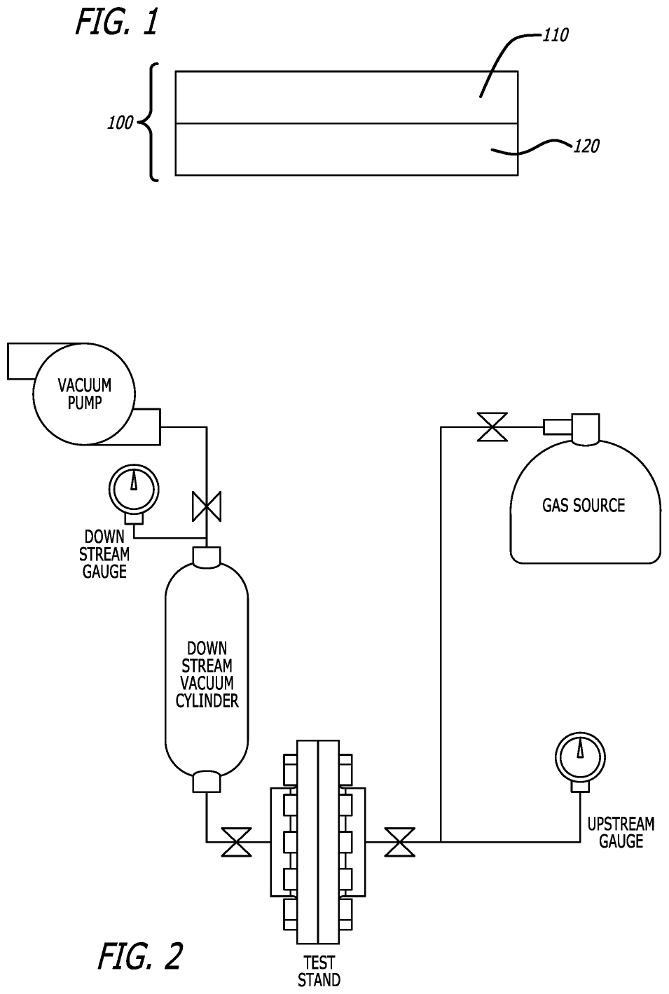

Generally, a dehydration membrane comprises a porous support and a composite coated onto the support. For example, as depicted in FIG. 1, selectively permeable membrane 100 can include porous support 120. composite coating 110 is coated onto the porous support 120. In some embodiments, the porous support comprises a polymer or hollow fibers. The porous support may be sandwiched between two composite layers. In other embodiments, the composite coating can be disposed on a surface of the porous support such that the composite coating may be in fluid communication with the support. In some embodiments, the composite coating can act as a protective layer to the porous support. In some embodiments, the composite coating can comprise a hydrophilic polymer.

In some embodiments, the water vapor gas passing through the membrane travels through all the components regardless of whether they are in physical communication or their order of arrangement.

A dehydration or water permeable membrane, such as one described herein, may be used to remove moisture from a gas stream. In some embodiments, a membrane may be disposed between a first gas component and a second gas component such that the components are in fluid communication through the membrane. In some embodiments, the first gas may contain a feed gas upstream and/or at the permeable membrane.

In some embodiments, the membrane can selectively allow water vapor to pass through while keeping other gases or a gas mixture, such as air, from passing through. In some embodiments, the membrane may be highly permeable to moisture. In some embodiments, the membrane can be minimally or impermeable to a gas or a gas mixture such as nitrogen or air. In some embodiments, the membrane may be a dehydration membrane. In some embodiments, the membrane may be an air dehydration membrane. In some embodiments, the membrane may be a gas separation membrane. In some embodiments, a membrane that is moisture permeable and/or gas impermeable barrier membrane containing graphene material, e.g., graphene oxide, may provide desired selectivity between water vapor and other gases. In some embodiments, the selectively permeable membrane may comprise multiple layers, where at least one layer is a layer containing graphene oxide material.

In some embodiments, the moisture permeability may be measured by water vapor transfer rate. In some embodiments, the membrane exhibits a normalized water vapor flow rate of about 500-2000 g/m²/day; about 1000-2000 g/m²/day, about 2000-3000 g/m²/day, about 3000-4000 g/m²/day, about 4000-5000 g/m²/day, about 3000-3500 g/m²/day, about 3500-4000 g/m²/day, about 4000-4500 g/m²/day, about 4500-5000 g/m²/day, at least about 3200-3400/m²/day, about 3400-3600 g/m²/day, about 3600-3800 g/m²/day, about 3800-3900 g/m²/day, about 3900-4000 g/m²/day, about 4000-4200 g/m²/day, about 4200-4400 g/m²/day, about 4400-4600 g/m²/day, about 4600-4800 g/m²/day, about 4800-4900 g/m²/day, or any normalized volumetric water vapor flow rate in a range bounded by any of these values. A suitable method for determining moisture (water vapor) transfer rates is ASTM E96.

In some embodiments, the gas or air permeability may be measured by the rate of nitrogen permeance. In some embodiments, the dehydration membrane can have a gas permeance that is less than 0.001 L/(m²·s·Pa), less than 1×10⁻⁴ L/(m²·s·Pa), less than 1×10⁻⁵ L/(m²·s·Pa), less than 1×10⁻⁶ L/(m²·s·Pa), less than 1×10⁻⁷ L/(m²·s·Pa), less than 1×10⁻⁸ L/(m²·s·Pa), less than 1×10⁻⁹ L/(m²·s·Pa), or less than 1×10⁻¹⁰ L/(m²·s·Pa), as determined by the Differential Pressure Method.

### Porous Support

A porous support may be any suitable material and in any suitable form upon which a layer, such as a layer[s] of the composite, may be deposited or disposed thereon. In some embodiments, the porous support can comprise hollow fibers or porous material. In some embodiments, the porous support may comprise a porous material, such as a polymer or a hollow fiber. Some porous supports can comprise a non-woven fabric. In some embodiments, the polymer may be a polyamide (e.g., a polyamide such as nylon), polyimide (PI), polyvinylidene fluoride (PVDF), polyethylene (PE), polypropylene (including stretched polypropylene), polyethylene terephthalate (PET), polysulfone (PSF), polyether sulfone (PES), cellulose acetate, polyacrylonitrile (e.g. PA200), or a combination thereof. In some embodiments, the polymer can comprise PET. In some embodiments the polypropylene is distended from a first length to a second length, where in the second length is at least 25%, 40%, 50%, 75% and/or greater than 100% of the first length. In some embodiments the polypropylene is distended from a first length to a second length within 1 minute, 5 minutes, 10 minutes, or 1 hour, wherein the second length is at least 25%, 40%, 50%, 75% and/or greater than 100% of the first length.

Composite Coating

The membranes described herein may comprise a composite coating which may comprise a PEBA and a hydrophilic inorganic filler. In some embodiments, the composite coating may be disposed on a surface of the porous support. In some embodiments, the composite coating increases the moisture permeability and lowers the gas permeability of the coated membrane. In some embodiments, the PEBA is a PEBAX® branded PEBA. In some embodiments, the PEBA is PEBAX® 1657.

In some embodiments, the PEBA has a weight ratio of poly(ethylene oxide) to polyamide of PEBA is about 0.1-0.5, about 0.5-1, about 1-1.5, about 1.5-2, about 2-3, about 3-4, about 4-5, about 1-2, about 1.2-1.4, about 1.4-1.6, or about 1.5 (60 mg of polyethylene oxide to 40 mg of polyamide is a ratio of 1.5).

In some embodiments, the composite coating can comprise hydrophilic inorganic filler. The hydrophilic inorganic filler can comprise a metal compound or salt, such as an aluminum compound or an aluminum salt, a calcium compound or a calcium salt, a sodium compound or a sodium salt, a silicon compound or a silicon salt, aluminum trihydrate (ATH), calcium chloride (CaCl₂)), a sodium aluminate, a sodium silicate, or a combination thereof. In an embodiment of particular interest, the hydrophilic inorganic filler comprises ATH. It is believed that the ATH forms a metal oxide layer (Al₂O₃) on the surface of the PEBA. It is believed the hydrophilic inorganic filler incorporation with PEBA increases the hydrophilicity of the membranes and reduces the matrix's pore size resulting in high moisture permeability and low gas permeability. In some embodiments, the hydrophilic inorganic filler can comprise a sodium aluminate. In still other embodiments, the hydrophilic filler can comprise a sodium silicate. In other examples, the hydrophilic filler can comprise calcium chloride (CaCl₂). In some examples, the PEBA and the hydrophilic inorganic filler are crosslinked. In some embodiments the PEBA and the ATH are crosslinked. Some embodiments include crosslinking the PEBA and CaCl₂). In some embodiments, the PEBA and sodium aluminate are crosslinked. In other embodiments, the PEBA and the sodium silicate are crosslinker. Some other embodiments describe crosslinking the PEBA and a combination of hydrophilic inorganic fillers.

In some embodiments, the weight ratio of the hydrophilic inorganic filler to the PEBA can be in a range of about 0.001 to about 0.5, about 0.01-0.4, about 0.005-0.01, about 0.008-0.012, about 0.01 to about 0.025, about 0.025 to about 0.03, about 0.03 to about 0.035, about 0.035 to about 0.04, about 0.04 to about 0.045, about 0.045 to about 0.05, about 0.05 to about 0.055, about 0.055 to about 0.06, about 0.06 to about 0.065, about 0.065 to about 0.07, about 0.07 to about 0.075, about 0.075 to about 0.08, about 0.08 to about 0.085, about 0.085 to about 0.09, about 0.09 to about 0.095, about 0.095 to about 0.1, about 0.1 to about 0.15, about 0.15 to about 0.2, about 0.2 to about 0.25, about 0.25 to about 0.3, about 0.3 to about 0.35, about 0.35 to about 0.4, about 0.4 to about 0.45, about 0.45 to about 0.5, about 0.01, about 0.03, about 0.05, about 0.06, about 0.1, about 0.3, or any ratio in a range bounded by any of these values.

In some embodiments, the composite coating can further comprise a graphene material. Some embodiments include a graphene oxide (GO) compound. It is believed that there may be a large number (˜30%) of epoxy groups on GO, which may be readily reactive with PEBA. It is also believed that the GO intercalates within the PEBA polymer matrix forming sheets have an extraordinarily high aspect ratio which provides a large available gas/water diffusion surface as compared to other materials, and it has the ability to decrease the effective pore diameter of any substrate supporting material to minimize contaminant infusion while retaining flux rates. It is also believed that the epoxy or hydroxyl groups increases the hydrophilicity of the materials, contributing to the increase in water vapor permeability and selectivity of the membrane. In some embodiments, the GO and the PEBA are crosslinked. In some embodiments, the GO and the hydrophilic inorganic filler are crosslinked. In some embodiments, the GO is crosslinked with both the hydrophilic inorganic filler and the PEBA.

In some embodiments, the composite containing the hydrophilicity agent can be coated on the support. In some embodiments, the composite containing the crosslinked GO compound can be coated on the support.

The composite coating can have any suitable thickness. For example, some composite coatings comprising PEBA, a hydrophilic inorganic filler and/or crosslinked GO-based layers may have a thickness of about 2-4 μm, about 0.1-0.5 μm, about 0.5-1 μm, about 1-1.5 μm, about 1.5-2 μm, about 2-2.5 μm, about 2.5-3 μm, about 3-3.5 μm, about 3.5-4 μm, about 1.8-2.2 μm, about 2.5-3.5 μm, about 2.8-3.2 μm, or any thickness in a range bounded by any of these values. Ranges or values above that encompass the following thicknesses are of particular interest: about 2 μm or about 3 μm.

Any suitable amount of a GO compound may be used. In some embodiments, the ratio of the GO to the PEBA can be about 0.001-0.05, about 0.001-0.02 (0.1 mg GO and 100 mg of the PEBA), 0.005-0.02 (0.5 mg GO and 100 mg of the PEBA is a ratio of 0.005), 0.001-0.002, about 0.002-0.003, about 0.003-0.004, about 0.004-0.005, about 0.005-0.006, about 0.006-0.007, about 0.007-0.008, about 0.008-0.009, about 0.009-0.01, about 0.01-0.011, about 0.011-0.012, about 0.012-0.013, about 0.013-0.014, about 0.014-0.015, about 0.015-0.016, about 0.016-0.017, about 0.017-0.018, about 0.018-0.019, about 0.019-0.02, about 0.01-0.02, about 0.02-0.03, about 0.03-0.05, about 0.01, or any ratio in a range bounded by any of these values.

In some embodiments, graphene oxide (GO) is suspended within the PEBA. The moieties of the GO and the PEBA may be bonded. The bonding may be chemical or physical. The bonding can be direct or indirect; such as in physical communication through at least one other moiety. In some composites, the graphene oxide and the crosslinkers may be chemically bonded to form a network of cross-linkages or a composite material. In some embodiments, the GO may be crosslinked with a hydrophilic inorganic filler. The bonding also can be physical to form a material matrix, wherein the GO is physically suspended within the PEBA.

It is believed that crosslinking the graphene oxide can enhance the dehydration mechanical strength of the membrane and water or water vapor permeability by creating strong chemical bonding between the moieties within the composite and wide channels between graphene oxide platelets to allow water or water vapor to pass through the graphene oxide platelets easily. In some embodiments, at least about 1%, at least about 5%, at least about 10%, at least about 20%, at least about 30%, at least about 40% about 50%, at least about 60%, at least about 70%, at least about 80%, at least about 90%, at least about 95%, or all of the graphene oxide platelets may be crosslinked. In some embodiments, the majority of the graphene material may be crosslinked. The amount of crosslinking may be estimated based on the weight of the cross-linker as compared to the total amount of graphene material.

In some examples, the composite coating mixture is prepared by mixing solutions and/or suspensions of the PEBA and the hydrophilic inorganic filler. In some embodiments the PEBA is dissolved in 70% ethanol (aqueous). In some examples, the inorganic filler is ATH. Some examples include mixing the ATH with a dispersant and a defoaming agent in water and pulverizing to prepare an ATH dispersion liquid. In some embodiments, the dispersant is Disperbyk-190. In some cases, the defoaming agent is BYK-024. Some examples include combining and an aqueous calcium chloride solution with the PEBA solution to prepare the composite coating solution. In some cases, an aqueous sodium silicate solution is mixed with the PEBA solution to form the composite coating solution. In some embodiments, an aqueous sodium aluminate solution is combined with the PEBA solution to form the composite coating solution. In some embodiments, an aqueous dispersion of GO is added to the PEBA/inorganic additive composite mixture. Some examples include sonicating the composite coating mixtures that comprise GO.

### Protective Coating

Some membranes may further comprise a protective coating. For example, the protective coating can be disposed on top of the membrane to protect it from the environment. The protective coating may have any composition suitable for protecting a membrane from the environment. Many polymers are suitable for use in a protective coating such as one or a mixture of hydrophilic polymers, e.g. polyvinyl alcohol (PVA), polyvinyl pyrrolidone (PVP), polyethylene glycol (PEG), polyethylene oxide (PEO), polyoxyethylene (POE), polyacrylic acid (PAA), polymethacrylic acid (PMMA) and polyacrylamide (PAM), polyethylenimine (PEI), poly(2-oxazoline), polyethersulfone (PES), methyl cellulose (MC), chitosan, poly (allylamine hydrochloride) (PAH) and poly (sodium 4-styrene sulfonate) (PSS), and any combinations thereof. In some embodiments, the protective coating can comprise PVA.

### Methods of Making Dehydration Membranes.

Some embodiments include methods for making a dehydration membrane comprising: (a) mixing the polymer, e.g., PEBAX, and an inorganic additive in an aqueous mixture to generate a composite coating mixture; (b) applying the composite coating mixture on a porous support to form a coated support; (c) repeating step (b) as necessary to achieve the desired thickness of coating; and (d) curing the coating at a temperature of about 60-120° C. for about 30 seconds to about 3 hours to facilitate crosslinking within the coated mixture. In some embodiments, a graphene oxide material can be mixed with the polymer and the additive. In some embodiments, the composite coating mixture further comprises a crosslinker comprising a polycarboxylic acid. In some embodiments, the method optionally comprises pre-treating the porous support. In some embodiments, the method optionally further comprises coating the assembly with a protective layer. An example of a possible embodiment of making an aforementioned membrane is shown in FIG. 1.

In some embodiments, the porous support can be optionally pre-treated to aid in the adhesion of the composite layer to the porous support. In some embodiments, the porous support can be modified to become more hydrophilic. For example, the modification can comprise a corona treatment using 70 W power with 2 counts at a speed of 0.5 meters per minute (hereinafter m/min). In some embodiments, the porous support can be stretched polypropylene. In some embodiments the polypropylene is distended from a first length to a second length, where in the second length is at least 25%, 40%, 50%, 100%, 200%, 500% and/or greater than 1000% of the first length. In some embodiments the polypropylene is distended from a first length to a second length, within 1 minute, 5 minutes, 10 minutes and/or 1 hour, where in the second length is at least 25%, 40%, 50%, 100%, 200%, 500% and/or greater than 1000% of the first length. In some embodiments, the distending is performed at a constant rate. A suitable stretched polypropylene can be Celgard 2500 polypropylene (Celgard LLC, Charlottle, N.C., USA). An exemplary stretching methodology can be on a stretching apparatus like KARO IV stretcher (manufactured by Bruckner Maschinenbau GmbH & Co. KG, Siegsdorf, GE); a preheating temperature of about 145 to 160° C.; preheating time of about 60 seconds; stretch ratio: sequential biaxial stretching to 5 times in longitudinal direction (machine direction) times; 7 times in transverse direction (area stretch ratio: 35); stretching rate of about 6 m/min; and the film thickness can be adjusted by way of preheating temperature as described in United States Patent Publication 2017/0190891.

In some embodiments, applying the mixture to the porous support can be done by methods known in the art for creating a layer of desired thickness. In some embodiments, applying the coating mixture to the substrate can be achieved by vacuum immersing the substrate into the coating mixture first, and then drawing the solution onto the substrate by applying a negative pressure gradient across the substrate until the desired coating thickness can be achieved. In some embodiments, applying the coating mixture to the substrate can be achieved by blade coating, spray coating, dip coating, die coating, or spin coating. In some embodiments, the method can further comprise gently rinsing the substrate with deionized water after each application of the coating mixture to remove excess loose material. In some embodiments, the coating is done such that a composite layer of a desired thickness is created. In some embodiments, the number of layers can range from 1-250, from about 1-100, from 1-50, from 1-20, from 1-15, from 1-10, or 1-5. This process results in a fully coated substrate, or a coated support.

The coating mixture that is applied to the substrate may include a solvent or a solvent mixture, such as an aqueous solvent, e.g. water optionally in combination with a water soluble organic solvent such as an alcohol (e.g. methanol, ethanol, isopropanol, etc.), acetone, etc. In some embodiments, the aqueous solvent mixture contains ethanol and water.

In some embodiments, the porous support is coated at a coating speed that is 0.5-15 m/min, about 0.5-5 m/min, about 5-10 m/min, or about 10-15 m/min. These coating speeds are particularly suitable for forming a coating layer having a thickness of about 1-3 μm, about 1 μm, about 1-2 μm, about 2 μm, about 2-3 μm, or about 3 μm.

For some methods, curing the coated support can then be done at temperatures and times sufficient to facilitate crosslinking between the moieties of the aqueous mixture deposited on the porous support. In some embodiments, the curing facilitates crosslinking between the PEBA and the hydrophilic inorganic filler. In some embodiments, the coated support can be heated at a temperature of about 60-120° C., about 60-70° C., about 70-80° C., about 80-90° C., about 90-100° C., about 100-110° C., about 110-120° C., about 85-95° C., about 105-115° C., or about 90° C., about 110° C., or about any temperature in a range bounded by any of these values. In some embodiments, the coated support can be heated for a duration of at least about 30 seconds, at least about 1 minute, at least about 5 minutes, at least about 6 minutes, at least about 15 minutes, at least about 30 minutes, at least 45 minutes, up to about 1 hour, up to about 1.5 hours, up to about 3 hours; with the time required generally decreasing for increasing temperatures. In some embodiments, the substrate can be heated at about 110° C. for about 5 minutes. This process results in a cured membrane.

In some embodiments, the method for fabricating a membrane can further comprise subsequently applying a protective coating on the membrane. In some embodiments, applying a protective coating comprises adding a hydrophilic polymer layer. In some embodiments, applying a protective coating comprises coating the membrane with a polyvinyl alcohol aqueous solution. Applying a protective layer can be achieved by methods such as blade coating, spray coating, dip coating, spin coating, and etc. In some embodiments, applying a protective layer can be achieved by dip coating of the membrane in a protective coating solution for about 1-10 minutes, about 1-5 minutes, about 5 minutes, or about 2 minutes. In some embodiments, the method further comprises drying the membrane at a temperature of about 60-120° C. for about 30 seconds to about 3 hours. Some embodiments include drying the membrane at a temperature of about 90-110° C. for about 1-10 minutes, or at about 110° C. for about 5 minutes. This process results in a membrane with a protective coating.

### Methods for Reducing Water Vapor Content of a Gas Mixture

A selectively permeable membrane, such as dehydration membrane, described herein may be used in methods for removing water vapor or reducing water vapor content from an unprocessed gas mixture, such as air, containing water vapor, for applications where dry gases or gases with low water vapor content are desired. The method comprises passing a first gas mixture (an unprocessed gas mixture), such as air, containing water vapor past the membrane, whereby the water vapor is allowed to pass through and be removed, while other gases in the gas mixture, such as air, are retained to generate a second gas mixture (a dehydrated gas mixture) with reduced water vapor content.

A dehydrating membrane may be incorporated into a device that provides a pressure gradient across the dehydrating membrane so that the gas to be dehydrated (the first gas) has a higher pressure than that of the water vapor on the opposite side of the dehydrating membrane where the water vapor is received, then removed, resulting in a dehydrated gas (the second gas).

The permeated gas mixture, such as air or a secondary dry sweep stream may be used to optimize the dehydration process. If the membrane were totally efficient in water vapor separation, all the water vapor in the feed stream would be removed, and there would be nothing left to sweep it out of the system. As the process proceeds, the partial pressure of the water vapor on the feed or bore side becomes lower, and the pressure on the shell-side becomes higher. This pressure difference tends to prevent additional water vapor from being expelled from the module. Since the object is to make the bore side dry, the pressure difference interferes with the desired operation of the device. A sweep stream may therefore be used to remove the water vapor from the shell side, in part by absorbing some of the water vapor, and in part by physically pushing the water vapor out.

If a sweep stream is used, it may come from an external dry source or a partial recycle of the product stream of the module. In general, the degree of dehumidification will depend on the pressure ratio of product flow to feed flow (for water vapor across the membrane) and on the product recovery. Good membranes have a high product recovery with low level of product humidity, and/or high volumetric product flow rates.

A dehydration membrane may be used to remove water for energy recovery ventilation (ERV). ERV is the energy recovery process of exchanging the energy contained in normally exhausted building or space air and using it to treat (precondition) the incoming outdoor ventilation air in residential and commercial HVAC systems. During the warmer seasons, an ERV system pre-cools and dehumidifies while humidifying and pre-heating in the cooler seasons.

In some embodiments, the dehydration membrane has a water vapor transmission rate that is at least 500 g/m²/day, at least 1,000 g/m²/day, at least 1,100 g/m²/day, at least 1,200 g/m²/day, at least 1,300 g/m²/day, at least 1,400 g/m²/day, or at least 1,500 g/m²/day, at least 1,600 g/m²/day, at least 1,700 g/m²/day, at least 1,800 g/m²/day, at least 1,900 g/m²/day, at least 2,000 g/m²/day, at least 2,100 g/m²/day, at least 2,200 g/m²/day, at least 2,300 g/m²/day, at least 2,400 g/m²/day, or at least 2,500 g/m²/day, at least 2,600 g/m²/day, at least 2,700 g/m²/day, at least 2,800 g/m²/day, at least 2,900 g/m²/day, at least 3,000 g/m²/day, at least 3,100 g/m²/day, at least 3,200 g/m²/day, at least 3,300 g/m²/day, at least 3,400 g/m²/day, or at least 3,500 g/m²/day, at least 3,600 g/m²/day, at least 3,700 g/m²/day, at least 3,800 g/m²/day, at least 3,900 g/m²/day, at least 4,000 g/m²/day, at least 4,100 g/m²/day, at least 4,200 g/m²/day, at least 4,300 g/m²/day, at least 4,400 g/m²/day, at least 4,500 g/m²/day, at least 4,600 g/m²/day, at least 4,700 g/m²/day, at least 3,400 g/m²/day, or at least 4,200 g/m²/day, as determined by ASTM E96 standard method.

In some embodiments, the dehydration membrane has a water vapor transmission rate that is at least 5000 g/m²/day, at least 10,000 g/m²/day, at least 20,000 g/m²/day, at least 25,000 g/m²/day, at least 30,000 g/m²/day, at least 35,000 g/m²/day, or at least 40,000 g/m²/day as determined by ASTM D-6701 standard method.

In some embodiments, the dehydration membrane has a gas permeance that is less than 0.001 L/(m²·s·Pa) less than 1×10⁻⁴ L/(m²·s·Pa), less than 1×10⁻⁵ L/(m²·s·Pa), less than 1×10⁻⁶ L/(m²·s·Pa), less than 1×10⁻⁷ L/(m²·s·Pa), less than 1×10⁻⁸ L/(m²·s·Pa), less than 1×10⁻⁹ L/(m²·s·Pa), or less than 1×10⁻¹⁰ L/(m²·s·Pa), as determined by the Differential Pressure Method.

The membranes described herein can be easily made at low cost and may outperform existing commercial membranes in volumetric product flow and/or product recovery.

### EMBODIMENTS

The following embodiments are specifically contemplated.
Embodiment 1. A dehydration membrane comprising:
   A porous support; and
   A composite coating, comprising a polyether block amide (PEBA) and an inorganic filler, wherein the composite coating increases moisture permeability and lowers gas permeability.
Embodiment 2. The dehydration membrane of embodiment 1, wherein the inorganic filler comprises aluminum trihydrate (ATH), calcium chloride (CaCl₂), sodium aluminate, or sodium silicate.
Embodiment 3. The dehydration membrane of embodiment 1, wherein the inorganic filler comprises aluminum trihydrate (ATH).
Embodiment 4. The dehydration membrane of embodiment 1, wherein the composite coating further comprises a graphene oxide compound.
Embodiment 5. The dehydration membrane of embodiment 1, wherein the weight ratio of the inorganic filler to the PEBA is between 0.01 to 0.4.
Embodiment 6. The dehydration membrane of embodiment 1, wherein the PEBA has a weight ratio of poly(ethylene oxide) to polyamide that is about 1.5.
Embodiment 7. The dehydration membrane of embodiment 1, wherein the membrane has a gas permeance that is less than 1.0×10⁻⁷ (m²·s·Pa) as determined by the Differential Pressure Method.
Embodiment 8. The dehydration membrane of embodiment 1, wherein the membrane has a water vapor transmission rate that is at least 3,400 g/m²/day as determined by ASTM E96 standard method.
Embodiment 9. The dehydration membrane of embodiment 1, wherein the porous support is selected from among polypropylene, polyethylene, polysulfone or polyether sulfone.
Embodiment 10. The dehydration membrane of embodiment 1, wherein the porous support comprises a stretched polypropylene.
Embodiment 11. A method of making a dehydration membrane comprising the steps of: (1) mixing PEBA and the inorganic filler in a solvent comprising 70% ethanol in water solvent; (2) applying the resulting mixture on a porous support in a layer of between 100 nm to about 3000 nm thick to form a protective coating on the porous support; (3) repeating step (2) as necessary to achieve the desired thickness; and (4) curing the protective coated support at a temperature of about 90° C. for about 1 to 5 minutes to facilitate solvent evaporation
Embodiment 12. The method of embodiment 11, wherein step (1) further comprise adding a graphene oxide compound to the mixture.
Embodiment 13. An energy recovery ventilator system comprising a dehydration membrane of embodiments 1, 2, 3, 4, 5, 6, 7, 8, 9, or 10.

### EXAMPLES

It has been discovered that embodiments of the selectively permeable membranes described herein have improved performance as compared to other selectively permeable membranes. These benefits are further demonstrated by the following examples, which are intended to be illustrative of the disclosure only but are not intended to limit the scope or underlying principles in any way.

### Example 1: Material and Membrane Preparation Procedure

### Example 1.1 Comparative Example-1 (CE-1): PEBA/Polypropylene Membrane

Coating Solution Preparation: 2.5 g PEBA (PEBAX MH1657 Arkema, Inc., King of Prussia, Pa., USA) was dissolved in 100 mL of solvent (70% EtOH in deionized (DI) water) in an 80° C. water bath with stirring. After the PEBA completely dissolved, the mixture was cooled to room temperature (RT). 25 mL of DI water was then added to the mixture in order to prepare a 2.5 wt % PEBA solution.

Coating and drying: The clearance coating bar was set 100 μm. A polypropylene film (Celgard 2500, Celgard, LLC, Charlotte, N.C., USA) was set upon a vacuum coating stage with a minimum/no wrinkles. The coating solution was deposited upon the polypropylene film. The coated film was dried on the stage for 2 minutes. The film was then dried in a 90° C. oven with air circulation for 3 minutes with a holder on both ends of the coated polypropylene film to reduce wrinkles.

### Example 1.2: Preparation of ATH Dispersion Solution

1000 g of aluminum trihydrate (MARTINAL OL-111LE, Albemarle Corporation, Charlotte, N.C., USA), 500 g of dispersant (Disperbyk-190, 40% solid content concentration, BYK, Wesel, Germany), 20 g of defoaming agent (BYK-024, BYK, Wesel, Germany) and 2,730 g of water were loaded into a pulverizer, and were pulverized for 30 minutes to prepare a ATH dispersion liquid having a particle diameter D10 of 85 nm, a particle diameter D50 of 127 nm, a particle diameter D90 of 320 nm and a maximum particle diameter of 687 nm in the number of particle size distribution of aluminum trihydrate.

The ATH dispersion was diluted with water to make a 2.5 wt % solution.

### Example 1.3 Preparation of PEBA/ATH (EX-1)

0.04 mL of 2.5% ATH dispersion solution was mixed with 4 mL of 2.5% PEBA solution and 1 mL of water to make a 100/1 (PEBA/ATH) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.4 Preparation of PEBA/ATH (EX-2)

0.12 mL of 2.5% ATH dispersion solution was mixed with 4 mL of 2.5% PEBA solution and 1 mL of water to make a 100/3 (PEBA/ATH) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.5 Preparation of PEBA/ATH (EX-3)

0.2 mL of 2.5% ATH dispersion solution was mixed with 4 mL of 2.5% PEBA solution and 1 mL of water to make a 100/5 (PEBA/ATH) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.6 Preparation of PEBA/ATH/GO

Preparation of GO solution: GO was prepared from graphite using the modified Hummers method. Graphite flakes (2.0 g) (Sigma Aldrich, St. Louis, Mo., USA, 100 mesh) were oxidized in a mixture of 2.0 g of NaNO₃ (Aldrich), 10 g KMnO₄ of (Aldrich) and 96 mL of concentrated H₂SO₄ (Aldrich, 98%) at 50° C. for 15 hours. The resulting paste like mixture was poured into 400 g of ice followed by adding 30 mL of hydrogen peroxide (Aldrich, 30%). The resulting solution was then stirred at room temperature for 2 hours to reduce the manganese dioxide, then filtered through a filter paper and washed with DI water. The solid was collected and then dispersed in DI water with stirring, centrifuged at 6300 rpm for 40 minutes, and the aqueous layer was decanted. The remaining solid was then dispersed in DI water again and the washing process was repeated 4 times. The purified GO was then dispersed in 10 mL of DI water under sonication (power of 10 W) for 2.5 hours resulting in a 0.4 wt % GO dispersion.

PEBA/ATH/GO EX-4: 0.25 mL of 0.4% GO dispersion was mixed with 4 mL of 2.5% PEBA solution and 1 mL of water. The resulting mixture was then sonicated for 2 minutes, after which 0.04 mL of 2.5% ATH dispersion solution was added to make a 100/1/1 (PEBA/ATH/GO) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.7 Preparation of PEBA/ATH/GO (EX-5)

0.25 mL of 0.4% GO dispersion was mixed with 4 mL of 2.5% PEBA solution and 1 mL of water. The resulting mixture was then sonicated for 2 minutes, after which 0.12 mL of 2.5% ATH dispersion solution was added to make a 100/3/1 (PEBA/ATH/GO) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.8 Preparation of PEBA/ATH/GO (EX-6)

0.25 mL of 0.4% GO dispersion was mixed with 4 mL of 2.5% PEBA solution and 1 mL of water. The resulting mixture was then sonicated for 2 minutes, after which 0.2 mL of 2.5% ATH dispersion solution was added to make a 100/5/1 (PEBA/ATH/GO) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.9 Preparation of PEBA/Sodium Aluminate (EX-7)

Sodium Aluminate solution: 5 g of sodium aluminate (MilliporeSigma, Burlington, Mass., USA) was dissolved in 100 mL of DI water, in order to make a 5 wt % solution.

EX-7: 0.06 mL of 5% sodium aluminate solution was mixed with 4 mL of 2.5% PEBA solution and 1.05 mL of water to make a 100/3 (PEBA/sodium aluminate) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.10 Preparation of PEBA/Sodium Aluminate (EX-8)

0.1 mL of 5% sodium aluminate solution was mixed with 4 mL of 2.5% PEBA solution and 1.1 mL of water to make a 100/5 (PEBA/sodium aluminate) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.11 Preparation of PEBA/Sodium Aluminate (EX-9)

0.6 mL of 5% sodium aluminate solution was mixed with 4 mL of 2.5% PEBA solution and 1.1 mL of water to make a 100/30 (PEBA/sodium aluminate) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.12 Preparation of PEBA/Sodium Silicate (EX-10)

Sodium Silicate solution: 3.6 mL of sodium silicate solution (MilliporeSigma) was added to DI water to yield a 5% solution of sodium silicate.

EX-10: 0.06 mL of 5% sodium aluminate solution was mixed with 4 mL of 2.5% PEBA solution and 1.05 mL of water to make a 100/3 (PEBA/sodium silicate) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.13 Preparation of PEBA/Sodium Silicate (EX-11)

0.1 mL of 5% sodium silicate solution was mixed with 4 mL of 2.5% PEBA solution and 1.1 mL of water to make a 100/5 (PEBA/sodium silicate) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 1.14 Preparation of PEBA/Sodium Silicate (EX-12)

0.6 mL of 5% sodium silicate solution was mixed with 4 mL of 2.5% PEBA solution and 1.1 mL of water to make a 100/30 (PEBA/sodium silicate) composite coating solution. The solution was coated onto polypropylene membrane as described above except the clearance of the coating bar set at 150 μm to reach a 3000 nm thickness, and the membrane was dried in a 110° C. oven with air circulation for 5 minutes with a holder on both ends of the coated polypropylene film to reduce wrinkles.

### Example 2.1: Measurement of Selectively Permeable Membranes

Membranes of EX-1, EX-2, EX-3, EX-4, EX-5, EX-6, EX-7, EX-8, EX-9, EX-10, EX-11 and EX-12 were tested for water vapor transmission rate (WVTR) as described in ASTM E96 standard method, at a temperature of 20° C. and 50% relative humidity (RH). The results are shown in Table 1.

### Example 2.2: Measurement of Membrane Nitrogen Permeance

Membranes of EX-1, EX-2, EX-3, EX-4, EX-5, EX-6, EX-7, EX-8, EX-9, EX-10, EX-11 and EX-12 were tested for nitrogen permeance using the Differential Pressure Gas Permeability method.

To determine the gas permeability of a dehydration membrane, an experimental setup similar to the one depicted in FIG. 2 was used. First, the sample to be measured was first enclosed in a filter pressure test stand (stainless steel, 47 mm dia., XX45 047 00, Millipore, Billerica, Mass. USA). The test stand was set up such that it was placed in fluid communication between a downstream vacuum cylinder (150 mL, 316L-HDF4-150, Swagelok, San Diego, Calif. USA) and a N₂ gas source, both isolated from the test stand via isolation valves. The downstream cylinder is in fluid communication with a vacuum pump via an isolation valve, which allows for evacuation of the downstream cylinder and then isolation before testing. Both downstream vacuum cylinder and the gas source are instrumented to read the pressures via an upstream gauge (MG1-100-9V, SSI Technologies, Janesville, Wis. USA) and a downstream gauge (DG25, Ashcroft Inc., Stratford, Conn. USA).

To prepare the sample for testing, once secure in the test stand the tee-valve is set to vacuum and the isolation values to the downstream vacuum so that the residual gas in the entire test section can be evacuated. Once evacuated, N₂ isolation valve is open and N₂ gas is flowed to the upstream side of the membrane. The tee-valve is then switched to the N₂ source. After the N₂ gas is flowing the pressure on the downstream vacuum side will change over the time.

From the downstream pressure rise as a function of time the flow of the N₂ gas through the membrane can be calculated, along with permeability. The results are shown in Table 1 below. From the results, it appears that the addition of hydrophilic inorganic fillers to PEBA reduces the N₂ permeability that the polyether block amide may inherently have.

TABLE 1
Water vapor transmission rate nitrogen permeance of PEBA, PEBA + hydrophilic
inorganic filler, and PEBA + hydrophilic inorganic filler + GO membranes.

| | | | | WVTR | | WVTR | |
|---|---|---|---|---|---|---|---|
| | | | | (20° C., | Nitrogen | (20° C., | Air |
| | | | | 50% RH) | Permeance | 50% RH) | permeance |
| | | | Thickness | Before Soaking | | Aft. 24 h 50° C. water soak | |
| | Composition | Ratio | (nm) | g/m²/day | L/(m² · s · Pa) | g/m²/day | L/(m² · s · Pa) |
| CE-1 | PEBA | 100 | 3000 | 3200 | 6.9 × 10⁻⁷ | | |
| EX-1 | PEBA/ATH | 100/1 | 3000 | 4020 | 1.9 × 10⁻⁸ | 4140 | 2.8 × 10⁻⁸ |
| EX-2 | PEBA/ATH | 100/3 | 3000 | 4777 | 1.7 × 10⁻⁸ | 4424 | 2.6 × 10⁻⁷ |
| EX-3 | PEBA/ATH | 100/5 | 3000 | 4620 | 8.6 × 10⁻⁹ | 4400 | 8.2 × 10⁻¹⁰ |
| EX-4 | PEBA/ATH/GO | 100/1/1 | 3000 | 3530 | 1.3 × 10⁻⁹ | | |
| EX-5 | PEBA/ATH/GO | 100/3/1 | 3000 | 4650 | 1.6 × 10⁻⁸ | | |
| EX-6 | PEBA/ATH/GO | 100/5/1 | 3000 | 4620 | 1.9 × 10⁻⁹ | | |
| EX-7 | PEBA/Sodium Aluminate | 100/3 | 3000 | 3560 | 5.3 × 10⁻⁹ | | |
| EX-8 | PEBA/Sodium Aluminate | 100/5 | 3000 | 3750 | 2.8 × 10⁻⁸ | | |
| EX-9 | PEBA/Sodium Aluminate | 100/30 | 3000 | 4793 | 1.8 × 10⁻⁸ | | |
| EX-10 | PEBA/Sodium Silicate | 100/6 | 3000 | 3600 | 7.4 × 10⁻⁹ | | |
| EX-11 | PEBA/Sodium Silicate | 100/10 | 3000 | 4200 | 8.6 × 10⁻⁹ | | |
| EX-12 | PEBA/Sodium Silicate | 100/30 | | 3770 | | | |

Unless otherwise indicated, all numbers expressing quantities of ingredients, properties such as molecular weight, reaction conditions, etc. used in herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sought to be achieved, and should, therefore, be considered as part of the disclosure. At the very least, the examples shown herein are for illustration only, not as an attempt to limit the scope of the disclosure.

The terms “a,” “an,” “the” and similar referents used in the context of describing embodiments of the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any claim. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the embodiments. Of course, variations on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A dehydration membrane comprising:
a porous support; and
a composite coating, comprising a polyether block amide (PEBA) and an inorganic filler, wherein the composite coating increases moisture permeability and decreases gas permeability.

2. The dehydration membrane of claim 1, wherein the inorganic filler comprises aluminum trihydrate (ATH), calcium chloride (CaCl₂), a sodium aluminate, a sodium silicate, or a combination thereof.

3. The dehydration membrane of claim 1, wherein the inorganic filler is aluminum trihydrate (ATH).

4. The dehydration membrane of claim 1, wherein the inorganic filler is calcium chloride (CaCl₂).

5. The dehydration membrane of claim 1, wherein the inorganic filler is a sodium aluminate.

6. The dehydration membrane of claim 1, wherein the inorganic filler is a sodium silicate.

7. The dehydration membrane of claim 1, wherein the PEBA is crosslinked to the inorganic filler.

8. The dehydration membrane of claim 1, wherein the composite coating further comprises a graphene oxide compound.

9. The dehydration membrane of claim 1, wherein the weight ratio of the inorganic filler to the PEBA is about 0.01 to about 0.4.

10. The dehydration membrane of claim 1, wherein the PEBA has a weight ratio of poly(ethylene oxide) to polyamide that is about 1.5.

11. The dehydration membrane of claim 8, wherein the weight ratio of the graphene oxide compound to the PEBA is about 0.01.

12. The dehydration membrane of claim 1, wherein the membrane has a nitrogen permeance that is less than 1.0×10⁻⁷ L/(m²·s·Pa) as determined by the Differential Pressure Method.

13. The dehydration membrane of claim 1, wherein the membrane has a water vapor transmission rate that is at least 3,400 g/m²/day as determined by ASTM E96 standard method.

14. The dehydration membrane of claim 1, wherein the porous support comprises polypropylene, polyethylene, polysulfone, polyether sulfone, or a combination thereof.

15. (canceled)

16. The dehydration membrane of claim 1, wherein the composite coating is a layer that has a thickness of about 2 μm to about 4 μm.

17. The dehydration membrane of claim 1, wherein the membrane further comprises a protective layer.

18. A method of making a dehydration membrane comprising the steps of: (1) mixing a PEBA and an inorganic filler in an aqueous mixture to generate a composite coating mixture; (2) applying the composite coating mixture on a porous support to form a coated support; (3) repeating step (2) as necessary in to achieve a desired thickness of between about 100 nm to about 3000 nm of coating on the porous support; and (4) curing the coated support at a temperature of about 60° C. to about 120° C. for about 30 seconds to about 3 hours to facilitate solvent evaporation and crosslinking.

19. The method of claim 18, wherein step (1) further comprises adding a graphene oxide compound to the composite coating mixture.

20. An energy recovery ventilator system comprising a dehydration membrane of claim 1.

21. A method of dehydrating a gas, comprising applying a gas pressure gradient across the dehydration membrane of claim 1, wherein a gas to be dehydrated applies a higher water vapor pressure to a first side of the membrane than a gas in contact with a second side of membrane, wherein water vapor passes through the membrane from the gas to be dehydrated and into the gas in contact with the second side of the membrane.
